(19) United States
(12) Patent Application Publication
(10) Pub. No.: US 2003/0036371 A1
(43) Pub. Date: Feb. 20, 2003

(54) Method of effectuating frequency switching by using two self-oscillating frequency reducers having a common input

(75) Inventor: Mao-Jen Chen, Chung-Li City (TW)

Correspondence Address: Bruce H. Troxell, DOUGHERTY & TROXELL, Suite 1404, 5205 Leesburg Pike, Falls Church, VA, 22041, US

(73) Assignee: Prime Electronics & Statellitcs Inc.

(21) Appl. No.: 09/928,494

(22) Filed: Aug. 14, 2001

(51) Int. Cl. H04B 1/06

(52) U.S. Cl. 455/277.1; 455/275; 455/279.1

(57) ABSTRACT

A method of effectuating frequency switching by using two self-oscillating frequency reducers having a common input includes the use of a three-way coupler to connect two field effect transistors (or two bipolar junction field effect transistors) and two dielectric resonator oscillators between a low-noise amplifier and an intermediate frequency (IF) amplifier, so as to effectuate switching between different frequency ranges. Thus, a simplified switch circuit for switching frequencies is possible to enable reduced manufacturing cost and reduced volume of device.

### FIELD OF THE INVENTION

The present invention relates to a method of effectuating frequency switching by using two self-oscillating frequency reducers having a common input, and more particularly to a method of effectuating frequency switch by using a three-way coupler to connect two field effect transistors (or two bipolar junction field effect transistors) and two dielectric resonator oscillators between a low-noise amplifier and an intermediate frequency amplifier. The method enables simplified switch circuit for switching frequencies and accordingly reduced manufacturing cost and device volume.

### BACKGROUND OF THE INVENTION

FIG. 1 is a schematic diagram showing a circuit of a conventional satellite frequency reducer. The circuit includes a signal receiver 10, a mixer 12 connected to a rear part of the receiver 10 between a low-noise amplifier 11 and an intermediate frequency (IF) amplifier 13, and two field effect transistors (MESFETs) or two bipolar junction transistors (BJTs) connected to the mixer 12. Thus, by using two transistors or two BJTs as local oscillators (LOs) 15, 16 and using two dielectric resonator oscillators (DROS) as reference frequencies, it is possible to switch between the reception of two different frequency ranges in order to achieve a complete signal reception.

The conventional satellite frequency reducer having the above-described structure includes a large number of components that result in a complicate circuit and accordingly increased cost and time for manufacturing the same.

In view of the complicate frequency selecting structure of the conventional satellite frequency reducer, it is tried by the inventor to develop an improved way of effectuating frequency switching to eliminate the drawbacks existing in the conventional satellite frequency reducer.

### SUMMARY OF THE INVENTION

A primary object of the present invention is to provide a method of effectuating frequency switching by using two self-oscillating frequency reducers having a common input. In the method of the present invention, a circuit having simpler and fewer number of components is adopted to reduce time and labor needed to produce the same and to reduce the volume of the product thereof, making the present invention industrially practical and valuable for use.

To achieve the above and other objects, the method of effectuating frequency switching by using two self-oscillating frequency reducers having a common input provided by the present invention is implemented on a circuit having a signal receiver and an output port. The method mainly includes the use of a three-way coupler to connect two field effect transistors (or two bipolar junction field effect transistors) and two dielectric resonator oscillators between a low-noise amplifier and an intermediate frequency (IF) amplifier that are located between the signal receiver and the output port of the circuit, so as to effectuate switching between different frequency ranges. Thus, a simplified switch circuit for switching frequencies is possible to enable reduced manufacturing cost and reduced volume of device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic diagram showing a circuit of a conventional satellite frequency reducer;

FIG. 2 is a schematic circuit diagram adopted in the present invention; and

FIG. 3 is a schematic block diagram showing the present invention.

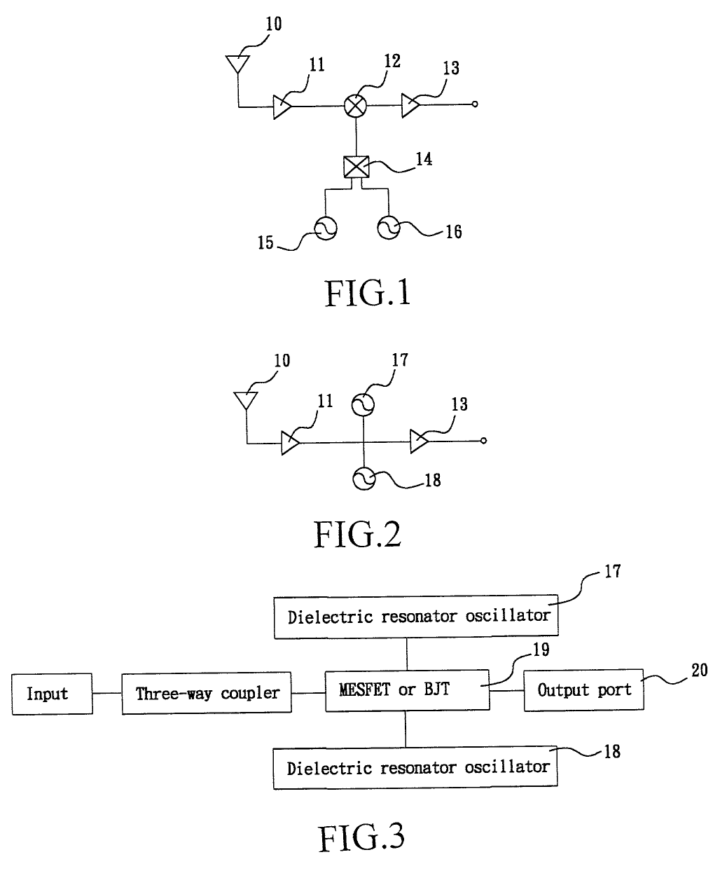

### DETAILED DESCRIPTION OF THE PREFERRED EMBODIMENTS

Please refer to FIG. 2 that is a schematic circuit diagram showing a circuit adopted in the method of the present invention to effectuate frequency switching by using two self-oscillating frequency reducers having a common input, and to FIG. 3 that is a block diagram of the present invention.

As shown in FIGS. 2 and 3, the circuit adopted in the method of the present invention includes a low-noise amplifier 11 and an intermediate frequency (IF) amplifier 13 behind a signal receiver or an input 10. The method of the present invention mainly includes the use of a three-way coupler to connect two field effect transistors (MESFETs) or two bipolar junction field effect transistors (BJTs) 19 and then two dielectric resonator oscillators 17, 18 between the low-noise amplifier 11 and the IF amplifier 13 so as to provide two self-oscillating frequency reducers. The above- described circuit is operative to effectuate automatic switching among multiple frequency ranges to avoid undesired missing of any signal to be received and is therefore an improvement in the art. An output port 20 is connected to a rear part of the above-described circuit for outputting the received signals.

In the present invention, the coupled circuit is simplified and the mixer is omitted to effectively reduce the number of electronic components used in the circuit. Meanwhile, the present invention enables a reduced volume of circuit to facilitate the miniaturization of devices.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method of effectuating frequency switching by using two self-oscillating frequency reducers having a common input being implemented on a circuit having a signal receiver and an output port, said method comprising the use of a three-way coupler to connect a field effect transistor and two dielectric resonator oscillators between a low-noise amplifier and an intermediate frequency amplifier that are located between said signal receiver and said output port of said circuit, in order to effectuate frequency switching.

2. A method of effectuating frequency switching by using two self-oscillating frequency reducers having a common input being implemented on a circuit having a signal receiver and an output port, said method comprising the use of a three-way coupler to connect a bipolar junction field effect transistor and two dielectric resonator oscillators between a low-noise amplifier and an intermediate frequency amplifier that are located between said signal receiver and said output port of said circuit, in order to effectuate frequency switching.
